(19) United States
(12) Patent Application Publication
(10) Pub. No.: US 2007/0084787 A1
(43) Pub. Date: Apr. 19, 2007

(54) Synthetic fiber pleatable filtration material and filter

(75) Inventors: Stephen Edward Gross, Dover, NH (US); Robert G. Sanders, Rochester, NH (US)

Correspondence Address: BIRCH STEWART KOLASCH & BIRCH, PO BOX 747, FALLS CHURCH, VA, 22040-0747, US

(73) Assignee: Lydall, Inc.

(21) Appl. No.: 11/439,988

(22) Filed: May 25, 2006

Related U.S. Application Data
(60) Provisional application No. 60/726,183, filed on Oct. 14, 2005.

(51) Int. Cl. B01D 29/07

(52) U.S. Cl. 210/493.1; 210/490; 210/503; 210/505

(57) ABSTRACT

The invention provides a method for pleating a filtration material (1), having at least one filtration layer (2) and a stiffening layer (4), comprising preparing the filtration layer (2) as a non-woven layer of synthetic fibers, preparing the stiffening support layer (4) as a non-woven layer of synthetic fibers, with a majority of the fibers having an average denier at least two times the average denier of the synthetic fibers of the filtration layer (2) and sufficient in number and denier so that when attached to the filtration layer (2) produces a self-supporting composite (5), forming lines (7) of spaced apart perforations (6) in the support layer (4) with the lines (7) corresponding to intended folds (121) in a pleated filtration material (120), attaching the perforated support layer (4) to the filtration layer (2) to form the composite (5) thereof, and pleating the composite filtration material (5) by folding the composite filtration material (5) along the lines (7) of the perforations (6) in the support layer (4). A corresponding filtration material and framed filter are also provided.

The present invention relates to filtration material made of synthetic fibers, and particularly to such material that may be formed into a pleated filtration material and filters made therefrom.

### BACKGROUND OF THE INVENTION

Most synthetic fiber filtration material currently available consists of one or more synthetic fiber layers of appropriate efficiency (filtration ability) attached to a support layer. The synthetic fibers are usually meltblown synthetic fibers, and the filtration media made therefrom normally does not have sufficient physical properties to be pleated into a rigid, self-supporting structure. Accordingly, the meltblown synthetic fiber layer(s) forming the filtration media is provided with a support layer attached thereto for forming the filtration material, which support layer provides the necessary additional physical properties. The support layer can be attached to the filtration media to form a composite by a variety of means, e.g., laminating, needling, stitching, et cetera, and the support layer can be made of various materials and by various processes, depending on the requirements of the finished filtration material. These include, but are not limited to, spunbonded polymers, such as polypropylene and polyester, resin bonded carded fabrics, and wet laid fabrics made from a variety of natural and/or synthetic fibers.

Generally the support layer contributes little to the filtration efficiency of the final filtration composite, although in some configurations there is a contribution to the dirt holding capabilities (See for example U.S. Pat. No. 6,579,350B2). It is, however, important that the support layer add as little resistance as possible to the fluid flow being filtered, since there is no commensurate increase in filter efficiency by the added support layer. The best support layers to accomplish these results are those comprised of synthetic fibers of circular cross section. Coarser diameter (higher denier) fibers are preferred over finer ones. This is due to the inherent lower specific surface area of coarser fibers, leading to less drag on the fluid flow being filtered, and consequently lower resistance to the flow of that fluid.

The physical properties of the so-produced composite filtration material are critical when processing into a pleated pack and ultimately into a finished filter. The pleating usually involves scoring transversely across the composite as it is fed into a conventional pleater, using a combination of compression, heat and other mechanical devices. The scoring is necessary so that when the filtration material is gathered into a final pleated pack configuration, it folds evenly, with relatively sharp creases at the tips of the pleats, along the score lines.

This scoring is fairly straightforward with the more usual glass fiber filtration material that is stiffer because of the relatively high modulus of the glass fibers and normally does not require a support layer. With glass fiber filtration material, the scoring imparts controlled damage to the glass fibers in the filtration material, breaking some of the glass fibers and creating weakened points that act as a hinge when folded into a pleated pack configuration. However, even with glass fiber filtration material, the nature and intensity of the scoring must be matched to the individual glass fiber material, and, hence, the scoring and pleating operations somewhat take on the nature of art rather than exact science.

However, with the use of synthetic fiber filtration material that require a support layer, particularly one made with the desirable coarse fibers, severe problems occur when processing the synthetic fiber filtration material into a pleated pack and ultimately into a finished filter. The fibers in the support layer are generally very tough, durable and resilient. As such, it is difficult to impart enough damage to the synthetic fibers of the filtration material to allow it to make sharp, stable pleats. If the synthetic fiber filtration material somewhat recovers from the scoring and pleating action, as it can, it typically makes the pleat tips and adjacent fabric more rounded, to the point the pleats can interfere with each other. This results in a poorly performing filter. The rounded tips can also degrade the aesthetic appearance of the filtration material and filters, which is an important consideration in many filter markets.

Current practice, therefore, uses high impact scoring systems, often thermally enhanced, to enable the synthetic fiber filtration material to be properly scored. Typically, knife blades of various configurations, scoring drums with heated blades, roller disc blades and the like impart considerable pressure or impact to the filtration material to effect adequate scoring. This is not only a relatively expensive operation, but also one which often substantially damages the filtration material and can cause leaks in or failure of the filtration material.

The pleating problems mentioned above in connection with synthetic fiber filtration material have been exacerbated by a trend in the art toward wider pleaters. Filters that previously were made on nominally 24 inch wide pleaters are now often being processed on 48 inch wide units. This trend is designed to increase production efficiency, but has the unintended consequence of increasing the difficulty of applying sufficient uniform pressure or impact across the filtration material width when high scoring pressures or impact are required. Therefore, often these wide pleaters are not capable of adequately pleating synthetic fiber filtration material, as described above.

### BRIEF DESCRIPTION OF THE INVENTION

The present invention is based of several discoveries and subsidiary discoveries.

First, it was discovered that the presence of the attachment step, i.e., attaching the filtration media, commonly referred to as the efficiency layer(s), to the support layer, commonly referred to as the scrim, offers an opportunity for improving the resulting filtration material. Thus, it was found that the support layer, before attachment to the synthetic filtration media, can be sufficiently perforated to cause adequate folding lines for the pleating process. After such perforation of the support layer, the synthetic fiber filtration media can be then attached to the perforated support layer. By so doing the damage to the so produced composite is only in connection with the support layer and not the synthetic filtration media. Thus, the prior art leaks and failure of the synthetic filtration material, as described above, are avoided. Further, since, as noted above, the support layer provides little or no additional filtration efficiency to the composite, the damage to the support layer is inconsequential.

As a further discovery, it was found that the damage to the support layer, being only in the area of the folded pleats, does not significantly degrade the ability of the support layer to perform its function of providing the required stiffness to the composite for good pleating.

As a subsidiary discovery, it was found that the perforations actually do less damage to the composite than the prior art impact or pressing of a knife blade or the like, since the perforations are but spaced apart damage.

As a further subsidiary discovery in this regard, it was found that the perforations need not be close together to provide adequate pleating, and as such can reduce the damage to the support layer by at least 30% as compared to the conventional knife blade damage, thus, providing an even better composite for forming the filter.

As yet another discovery, it was found that the perforations can vary in configurations and the specific configurations can be adapted to provide optimum folding and thus pleating for any specific synthetic fiber material. This provides far more latitude to the present “scoring” process than that available in the prior art.

In this latter regard, there are several different processes that can be used to perforate the support layer, including lasers, ultrasonic, electrostatic, pin tools and modified slitters. Thus, considering the present perforations as being a type of “better controlled damage”, the present invention gives wide latitude for adapting the particular type of perforation and means of producing those perforations to the particular synthetic filtration material involved.

Accordingly, the basic feature of the present invention is that pre-scoring the support layer with perforations transversely across the support layer prior to attaching the support layer to the synthetic fiber filtration media, i.e., the efficiency layer(s). These perforation lines, thus, in effect, correspond to the standard prior art pleating score lines, e.g., every 2 to 6 inches. With the present invention, however, the degree of “damage” is controlled by adjusting the perforations, e.g., the density across the support layer (number of perforation per inch), the size of the perforations, the shape of the perforations (round vs. ovals vs. slots and so forth) etc. The proper configuration(s) of the perforations depends on the nature of the support layer being pre-scored (perforated), the efficiency layer (filtration media) being used, the type of attachment technique used and the design of the finished filter. When properly executed, the synthetic filtration media bypasses the scoring section of the pleater, and the composite of the filtration media and the support layer is accurately folded (pleated) into folded “packs”, with the pleating precision being controlled by the location and details of the perforations only in the support layer.

It should be fully understood that perforations are not an option in traditionally made synthetic filter material (the filtration media and the support layer are attached before being scored), since each perforation would, at the very least, be a potential leak. In the case of the present synthetic fiber filtration material, this is not an issue, since the filtration media is not perforated and the slight compromising of the support layer with perforations has only a negligible effect on the filtration efficiency of the finished composite.

It is noted that for purposes of the present invention, the term “perforations” is not narrowly defined. Points resembling perforations that impart the proper amount of damage, but do not actually penetrate or only partially penetrate the support layer, are included as part of the invention. However, nearly full or full perforations are the preferred configuration(s).

As a further part of the invention, when normally scoring a synthetic fiber filtration material, according to the prior art process, the resulting pleat tips exhibit compressed characteristics due to the scoring. This results in a high resistance to fluid flow at a critical location in the filter. Use of perforations in the support layer at this point actually serves to lower the overall resistance of fluid flow in the final filter rather than increase this critical parameter, and as such is a further feature of the invention.

As yet a further feature of the invention, it is advantageous to perforate the support layer as it is being fed into the attachment, usually lamination, process. This ensures that the proper pleat spacing is set just prior to assembly of the composite and avoids the difficult task of accurately registering the perforation lines with the filtration media when the perforations are place in the support layer sometime prior to the attachment process.

Thus, briefly stated, the present invention provides a method for pleating a filter material, having at least one filtration layer and a stiffening support layer, comprising preparing the filtration layer as a non-woven layer of synthetic fibers, preparing the stiffening layer as a non-woven layer of synthetic fibers, with a majority of the fibers having an average denier at least two times the average denier of the synthetic fibers of the filtration layer and sufficient in number and denier so that when attached to the filtration layer produces a self-supporting composite, forming lines of spaced apart perforations in the support layer with the lines corresponding to intended folds in a pleated form of the composite, attaching the perforated support layer to the filtration layer to form the composite thereof, and pleating the composite by folding the composite along the lines of the perforations in the support layer.

The invention also provides the corresponding composite filtration material.

### BRIEF DESCRIPTION OF THE DRAWINGS

FIG. 1 is a diagrammatic isometric view of the filter material of the invention;

FIG. 2 is a diagrammatic cross-section of the filter material of the invention taken along the view II-II of FIG. 1;

FIG. 3 is top view of a disposition of adhesive drops on the filtration layer just prior to lamination to the support layer;

FIG. 4 is a detailed diagrammatic view of a line of perforations;

FIG. 5 is a diagrammatic side view of a suitable means of perforating the support layer;

FIGS. 6, 7, and 8 are diagrammatic end views of perforators suitable for use with the invention;

FIG. 9 is a diagrammatic end view of a preferred means of perforating the support layer;

FIG. 10 is a diagrammatic side view of a suitable means of applying an adhesive to the filtration layer;

FIG. 11 is a diagrammatic cross-section of a form of the filter material; and

FIG. 12 is a diagrammatic exploded view of a filter according to the invention.

### DETAILED DESCRIPTION OF THE INVENTION

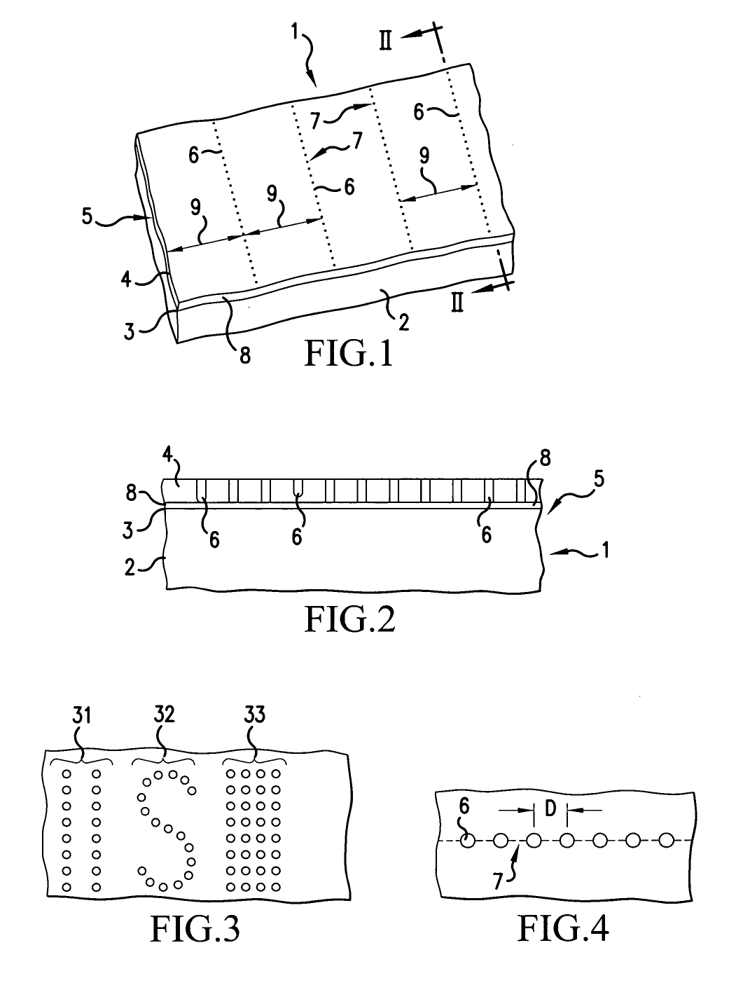

As can best be seen from FIG. 1, which is a diagrammatic isometric view of the composite filtration material of the present invention, the filtration material, generally (1), is composed of at least one filtration layer (2) attached at interface (3) to at least one stiffening support layer (4) to form a composite, generally (5) thereof. The support layer (4) has a plurality of spaced apart perforations (6) defining a plurality of spaced apart lines (7) of the perforations (6). It will be noted that the filtration layer (2) has essentially no perforations therein, as can best be seen from FIG. 2, which is a cross-section of FIG. 1 taken along view II-II.

The filtration layer (2) can be made of a wide variety of synthetic fibers, including but not limited to polyolefins, polyesters, nylon, rayons, polyvinyl chlorides, and the like, and that layer can be made by a variety of processes, including spinning, felting and melt blowing. However, it is preferred that the filtration layer (2) is composed of meltblown fibers, which are meltblown into at least one layer, e. g., multiple lapped layers. Likewise, the support layer (4) may be formed of a wide variety of synthetic fibers, as noted above in connection with the filtration layer, and the support layer may be made by melt blowing, air laying, felting, wet laying, and the like. However, it is preferred that the fibers of the filtration layer are polyolefin fibers, and especially polyethylene or polypropylene fibers. Again, while the fibers of the filtration layer (2) can vary considerably in deniers and lengths, it is preferred that the fibers of that layer have deniers of about 0.1 to 500 microns and especially from about 1 to 50 microns. The length can vary from as little as 2 mm to as long as 2 cm, but preferably the length will be between about 0.5 cm and 1.5 cm.

While the lengths of the fibers of the support layer may be similar to those of the filtration layer, the average deniers of the fibers of the support layer should be at least twice that of the fibers of the filtration layer in order to prove the required stiffening of that layer. The deniers of the fibers of the support layer can be up to about 50 times the deniers of the fibers of the filtration layer, but ranges of between 5 and 10 times are preferred.

Likewise, the weight of the filtration layer may vary widely, e.g., from about 1 to 1,000 grams per square meter, but preferably that weight is from about 10 to 100 grams per square meter. The weight of the support layer can be from 0.1 to 5 grams per square meter, but from about 0.5 to 1 gram per square meter is preferred.

Filtration layer (2) is attached to support layer (4) at interface (3) by a variety of means, such as needling, stitching, melt bonding or adhesion. For example, the two layers may be stitched together in a conventional needling or stitching machine, or meltable fibers may be placed between the two layers and heat applied to at least one of the layers to cause the meltable fibers to melt and bond the two layers together. However, it is preferred that the two layers be attached by adhesion, i.e., that the two layers are attached by an adhesive (8)—See FIGS. 1 and 2. While the adhesive may be chosen from a wide variety of adhesives, such as cellulosic adhesives, polystyrene adhesives, polyvinyl chloride adhesives, and the like, it is preferred that the adhesive be a polyester adhesive, and particularly a polyethylene terephathalate adhesive.

The adhesive can be applied to the composite in substantially differing amounts, but it must be kept in mind that the composite is intended to be a filtration material, and the adhesive must not substantially blind the composite to passage of a fluid being filtered. Polyester adhesives, in particular polyethylene terephathalate adhesives, are particularly useful, since they can be applied to form the composite in very small amounts, e.g., in weights of from as little as 0.01 to 100 grams per square meter, and especially 0.5 to 25 grams per square meter.

The adhesive can be applied to the composite as a liquid or solid. For example, the adhesive may be in the form of meltable fibers applied to the composite or in the form of discrete drops applied to the composite in conventional manners, e.g., by sprayer. It is preferred that the adhesive be applied to the composite by spraying such as to form discrete, spaced apart drops of the adhesive. By spraying the adhesive, the adhesive can be more uniformly dispersed between the two layers and, accordingly, good adhesion can be provided with a minimum amount of adhesive. This provides less pressure drop through the filter because of the decreased filtration area caused by the presence of the adhesive. The size or width of the drops can vary considerably, but again bearing in mind the need to not substantially blind the filtration material for filtration purposes, it is preferred that the discrete drops of adhesive have a width of from about 0.5 microns to about 1,000 microns, and more particularly from about 5 microns to about 100 microns.

The drops may be sprayed in a predetermined pattern or a variety of predetermined patterns, as show in FIG. 3. One such pattern is shown as a pattern of parallel lines (31), or in an “S” configuration (32), or in the configuration of disconnected lines (33). Irrespective of the particular pattern or a random application, the drops should not cover more than 10%, especially less than 5% of the area of the composite, and this is easily achieved when the adhesive is applied by spraying, as noted above. But to ensure good adhesion, the drops should cover at least 0.1 and more particularly about 0.5% of the area of the composite.

The spacing, shown by arrows (9) in FIG. 1 between lines (7) of perforations (6) in the support layer (4) should correspond to the distance between folds in an intended filter. While this can vary widely, depending up on the filter intended, e.g., from as little as about 0.1 inch, more usually those spacings will be at least 0.5 inches between intended folds. The spacings between lines (7) of perforations (6), i.e., between folds, can be quite large, e.g., up to 24 inches, but usually that spacing will be about six inches or less.

As best seen in FIG. 2, the perforations (6) can just penetrate the support layer (4), as shown by the left-hand most perforation (6), or not completely penetrate the support layer (4), as shown by the middle perforation (6), or considerably penetrate through the support layer (4), as shown by the right-hand perforation (6). It is, however, not generally necessary that the perforations pass entirely through the support layer, although they may do so if desired to ensure a very good folding line of perforations, especially when the support layer is on the thicker and heavier side, as described by the above ranges. However, it is preferred that the average perforation just penetrates or not entirely penetrates through the support layer.

The perforations (6) may be spaced apart from each other a distance D, as seen in FIG. 4, with considerably latitude, but generally speaking, the perforations are spaced apart so that the lines (7) of perforations (6) have from about 10% to about 90% of each line (7) perforated, but more usually from about 20% to 80% of each line (7) is perforated. The spacing apart of the perforations will depend, in part, on the size of the perforations, which can be from about 0.1 to about 10 mm in width, but more generally are from about 0.3 to 2 mm in width. With this latter size of perforations, the perforations are spaced apart from about 1 to 3 mm, but more generally between 0.75 and 2.5 mm. A preferred embodiment is where the perforations are about 1 mm in width and are spaced apart about 1.5 mm. This gives very good lines of perforations for folding the composite into a very neat filter. The distance D may be uniform in a line (7) or vary. The perforations may be uniform, e.g., produced from uniformly configured perforators, or they may be different. However, it is preferred that the perforations are substantially uniformly spaced apart in a line of perforations and uniformly configured.

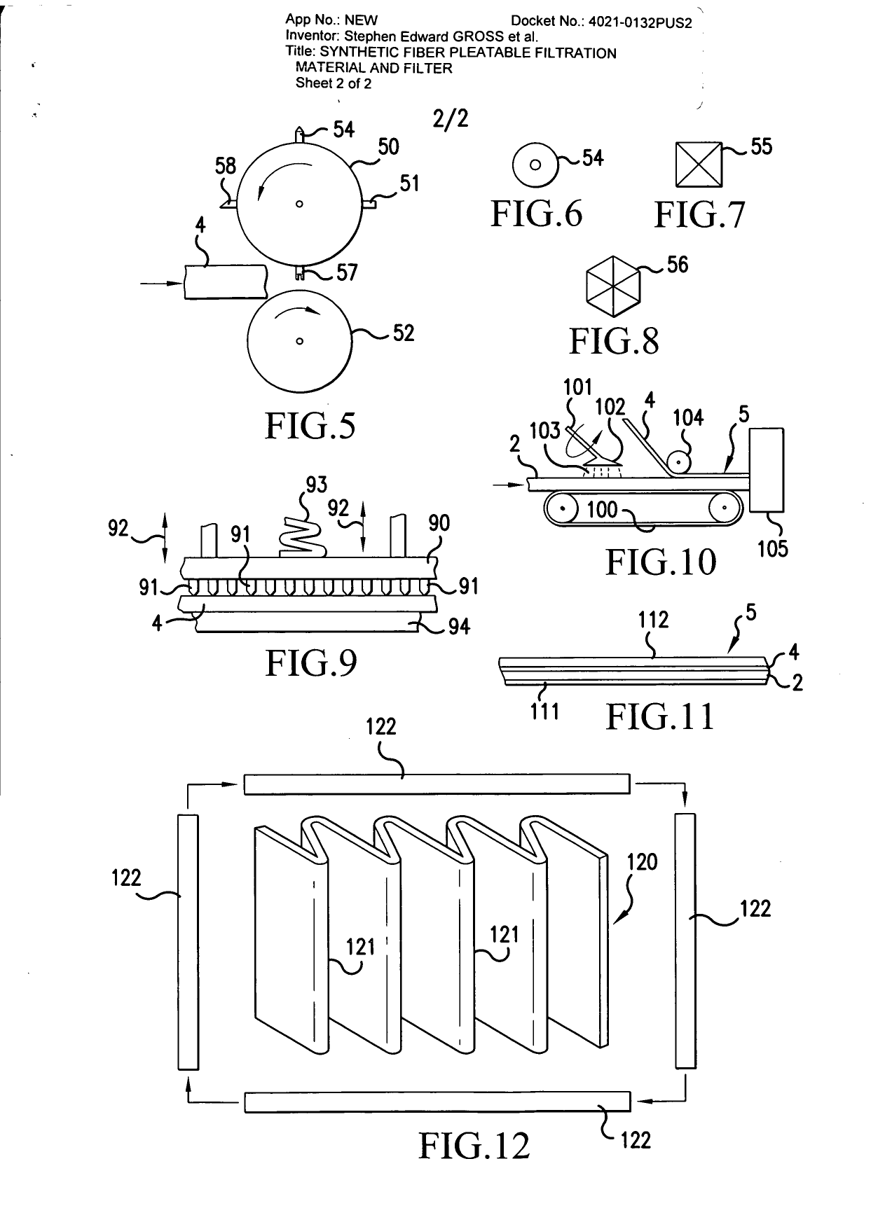

The perforations may be produced by passing the support layer (4) (see FIG. 5) through counter-rotating rolls. A perforator roll (50) has perforators (51) along the periphery thereof. And a pressure roll (52) forces the support layer (4) between those two counter-rotating rolls. The perforations will extend in a line (into the paper as seen in FIG. 5) along the periphery of the perforator roll (51) so as to produce the lines (7) of perforations (6), shown in FIG. 1.

The perforators may take a variety of configurations, as shown in FIGS. 6, 7 and 8, where a conical perforator (54) is shown in FIG. 6, a square perforator (55) is shown in FIG. 7 and a hexagonal perforator (56) is shown in FIG. 8. Any desired shape could be used, including a blunt end (shown as perforator (51) in FIG. 5), or a “H” end (shown as perforator (57) in FIG. 5), or slant end (shown as perforator (58) in FIG. 5), or a conical end (shown as perforator (54) in FIG. 5), or any other desired shape so long as sufficient perforations are made to achieve the folding characteristics of the invention.

A preferred form of forming perforations is shown in FIG. 9, where a perforator bar (90) has a plurality of perforators (91) and is actuated reciprocally up and down as shown by arrows (92). This can be by way of, for example, an eccentric (not shown) driving perforator bar (90) in combination with a return spring (93), or actuated hydraulic pistons (not shown) can achieve that reciprocal motion, or any other desired mechanical means. A receiving bed (94) may be perforated (not shown) to receive perforators (91) so that the perforations may pass through support layer (4), or the receiving bed (94) may simply be a resilient member or a resilient covered member, such as a rubber covering, which will allow the perforations to substantially penetrate, but not completely penetrate support layer (4) during passage of the support layer (4) through the mechanism in the direction of a line into the paper of the drawing.

A preferred form of the process for producing the filtration material (1) having at least one filtration layer (2) and a stiffening support layer (4) is that of preparing the filtration layer (2) as a non-woven layer of synthetic fibers; preparing the stiffening support layer (4) as non-woven layer of synthetic fibers, with the majority of the fibers having an average denier at least two times the average denier of the synthetic fibers of the filtration layer and sufficient in number and denier so that when attached to the filtration layer produces a self-supporting composite (5). Lines (7) of spaced apart perforations (6) are produced in the support layer (4) with the lines corresponding to the intended fold in the pleated form of the composite (shown in FIG. 12 as pleated form, generally (120)).

The filtration layer (2), as diagrammatically shown in FIG. 10, is fed to a conveyor system, e.g., a conveyor belt (100), and a spray arm (101) with a spray head (102) sprays adhesive (103) in a pattern, such as those shown in FIG. 3, onto filtration layer (2). The already perforated support layer (4) is pressed against filtration layer (2) by means of pressure roll (104) to cause adherence of the support layer (4) to filtration layer (2) to form, generally, composite (5). Alternatively, the adhesive may be sprayed onto the support layer (4).

Thereafter, the composite is treated in conventional equipment to form pleated filtration material, generally (120), as shown in FIG. 12. It is not necessary to describe that conventional equipment, since it is well known to the art and is simply indicated in FIG. 10 as conventional pleater and folder (105). However, basically, the pleater and folder gathers lengths of the composite (5) and by pusher or gathering arms or the like, causes the material to fold at the lines of perforations (6) (FIG. 1) so as to configure into the pleated form of the filtration material, generally (120), with pleats (121), as shown in FIG. 12.

While the filtration material (1) must have a filtration layer (2) and support layer (4) to form a composite, generally (5), as shown in FIG. 11, it may have additional layers attached thereto in any of the manners described above in connection with attaching the support layer to the filtration layer. For example, the composite may have a dust gathering layer (111) or a pre-filter (112), both of conventional design, or any additional decorative or functional layers as may be desired, again as shown in FIG. 11.

After passing through the conventional pleater and folder (105), as shown in FIG. 10, the pleated filtration material, generally (120), shown in FIG. 12, is placed in an conventional filter frame (122), shown in an exploded view in FIG. 12. This forms the completed and finished filter.

In addition, further layers may form conventional density gradient structures which are applied to the filtration material to assist in dirt loading, filter longevity and the like.

Thus, the invention provides an easily pleatable filtration material which does not suffer from the disadvantages of the prior art and achieves efficient filtration at a very low cost.

1. A method for pleating a filtration material (1), having at least one filtration layer (2), and a stiffening support layer (4), comprising
(1) preparing the filtration layer (2) as a non-woven layer of synthetic fibers;
(2) preparing the stiffening support layer (4) as a non-woven layer of synthetic fibers, with a majority of the fibers having an average denier at least two times the average denier of the synthetic fibers of the filtration layer and sufficient in number and denier so that when attached to the filtration layer (2) produces a self-supporting composite (5);
(3) forming lines (7) of spaced apart perforations (6) in the support layer (4) with the lines (7) corresponding to intended folds (121) in a pleated filtration material (120) of the composite (5);
(4) attaching the perforated support layer (4) to the filtration layer (2) to form a composite filtration material (5) thereof; and
(5) pleating the composite filtration material (5) by folding it along the lines (7) of the perforations (6) in the support layer (4).

2. The method of claim 1, wherein the filtration layer is a meltblown layer

3. The method of claim 1, wherein the support layer is a meltblown, air laid, felted or wet laid layer.

4. The method of claim 2, wherein the fibers of the filtration layer are polyolefin fibers.

5. The method of claim 4, wherein the fibers of the filtration layer are polyethylene or polypropylene fibers.

6. The method of claim 1, wherein the fibers of the filtration layer have deniers of about 1 micron to about 50 microns.

7. The method of claim 1, wherein the filtration layer has a weight from about 10 to 100 grams per square meter.

8. The method of claim 1, wherein the filtration layer is attached to the support layer by needling, stitching, adhesion or meltbonding.

9. The method of claim 8, wherein the attachment is by adhesion and an adhesive thereof is a polyester adhesive.

10. The method of claim 9, wherein the polyester adhesive is a polyethylene terephathalate adhesive and the adhesive is applied to the composite in weights of about 0.5 to 25 grams per square meter.

11. The method of claim 10, wherein the adhesive is in the form of meltable fibers.

12. The method of claim 10, wherein the adhesive is in the form of discrete drops of a width of from about 5 microns to 100 microns.

13. The method of claim 12, wherein the drops are sprayed in a determined pattern and the drops cover from about 0.5% to 5% of the area of the composite.

14. The method of claim 1, wherein the lines (7) of perforations (6) in the support layer (4) are spaced apart from about 0.5 inch to about 6 inches.

15. The process of claim 1, wherein the average perforation (6) just does penetrate or does not entirely penetrate through the support layer (4).

16. The process of claim 1, wherein the perforations (4) are spaced apart so that a line (7) of perforations (6) has from about 20% to 80% of the line perforated.

17. The process of claim 1, wherein the perforations (6) are about 0.3 to 2 mm in width and are spaced apart from about 0.75 to 2.50 mm.

18. The process of claim 17, wherein the perforations are about 1 mm in width and are spaced apart about 1.5 mm.

19. The process of claim 18, wherein its perforations are substantially uniformly spaced apart in a line of perforation.

20. A composite filtration material (1), comprising at least one filtration layer (2) attached at an interface (3) to a stiffening support layer (4) to form a composite (5) thereof, and wherein the support layer (4) has a plurality of spaced apart perforations (6) defining a plurality of spaced apart lines (7) of the perforations (6) and the filtration layer (2) has essentially no perforations (4) therein.

21. The composite of claim 20, wherein the filtration layer (2) is a meltblown layer.

22. The composite of claim 20, wherein the support layer (4) is a meltblown, air laid, felted or wet laid layer.

23. The composite of claim 21, wherein the fibers of the filtration layer are polyolefin fibers.

24. The composite of claim 23, wherein the fibers of the filtration layer are polyethylene or polypropylene fibers.

25. The composite of claim 20, wherein the fibers of the filtration layer (2) have deniers of about 1 micron to about 50 microns.

26. The composite of claim 25, wherein the filtration layer has a weight of about 10 to 100 grams per square meter.

27. The composite of claim 20, wherein the filtration layer is attached to the support layer at the interface by needling, stitching, adhesion or meltbonding.

28. The composite of claim 27, wherein the attachment is by adhesion and an adhesive thereof is a polyester adhesive.

29. The composite of claim 28, wherein the polyester adhesive is a polyethylene terephathalate adhesive and the adhesive is applied to the composite in weights of about 0.5 to 25 grams per square meter.

30. The composite of claim 29, wherein the adhesive is in the form of discrete drops.

31. The composite of claim 30, wherein the adhesive is in the form of discrete drops of a width of from about 5 microns to 100 microns.

32. The composite of claim 30, wherein the drops are sprayed in a determined pattern and the drops cover from about 0.5% to 5% of the area of the composite.

33. The composite of claim 20, wherein the lines (7) of perforations (6) in the support layer (4) are spaced apart from about 0.5 inch to about 6 inches.

34. The composite of claim 20, wherein the average perforation just does or does not entirely penetrate through the support layer.

35. The composite of claim 20, wherein the perforations (6) are spaced apart so that a line (7) of perforations (6) has from about 20% to 80% of the line perforated.

36. The composite of claim 35, wherein the perforations are about 0.3 to 2 mm in width and are spaced apart from about 0.75 to 2.50 mm.

37. The composite of claim 36, wherein the perforations are about 1 mm in width and spaced apart about 1.5 mm.

38. The composite of claim 37, wherein the perforations are substantially uniformly spaced apart in a line of perforations.

39. The composite of claim 20, wherein the composite filtration material (5) is folded into a pleated configuration suitable for forming into a filter.

40. A filter comprising a frame (122) and the filtration material (1) of claim 1.
